(19) United States
(12) Patent Application Publication
(10) Pub. No.: US 2016/0159006 A1
(43) Pub. Date: Jun. 9, 2016

(54) PNEUMATIC MANUFACTURING SYSTEM FOR COMPLEX TISSUES AND ORGANS, HAVING MULTIPLE DEGREES OF FREEDOM AND MULTIPLE NOZZLES

(71) Applicant: TSINGHUA UNIVERSITY, Beijing (CN)

(72) Inventors: Xiaohong Wang, Beijing (CN); Libiao Liu, Beijing (CN)

(21) Appl. No.: 14/888,669

(22) PCT Filed: Mar. 24, 2014
(86) PCT No.: PCT/CN2014/073945

§ 371 Date: Nov. 2, 2015

(30) Foreign Application Priority Data
May 3, 2013 (CN) 201310159590.8

(51) Int. Cl. B29C 67/00

(52) U.S. Cl. CPC B29C 67/0055; B29C 67/0088; B33Y 30/00

(57) ABSTRACT

Disclosed is a pneumatic manufacturing system for complex tissues and organs, having multiple degrees of freedom and multiple nozzles, belonging to the organs manufacturing field. The system comprises an X-direction movement mechanism, a Y-direction movement mechanism, a Q-direction rotation mechanism, a lifting platform, a rotation-forming platform, a shell, a high-pressure gas source, a multiple-nozzle forming unit, a spraying solution pressure tank, a temperature control device, a sterilizing device and a control unit. Under the control of the control unit, the multiple-nozzle forming unit will move according to a given path and spray in accordance with a given order, wherein the range of sizes which can be formed is wide and the relative angle between the central axis of a spray valve and the surface of the rotation-forming platform can also vary, convenient for manufacturing a complex curved surface. The system enables multiple cells and scaffold materials to be arranged at the corresponding positions according to a computer instruction at one time while completing various finishing sequences, wherein the formed three-dimensional structure may directly connect with a corresponding circulatory system in vivo and quickly realize various physiological functions of a complex tissue and organ.

### CROSS-REFERENCE TO RELATED APPLICATIONS

The present application claims benefit of priority to PCT Application No. PCT/CN2014/073945, entitled “PNEUMATIC MANUFACTURING SYSTEM FOR COMPLEX TISSUES AND ORGANS, HAVING MULTIPLE DEGREES OF FREEDOM AND MULTIPLE NOZZLES” and filed on 24 Mar. 2014, which is specifically incorporated by reference herein for all that it discloses or teaches.

### TECHNICAL FIELD

The present invention is directed to organs manufacturing field, and specifically relates to a pneumatic manufacturing system for complex tissues and organs, having multiple degrees of freedom and multiple nozzles.

### BACKGROUND

In the late 1980s, rapid prototyping technique, as an relatively important member of advanced manufacturing techniques, was introduced into the field of scaffold formation, which provided a new idea for resolving the problems existed in traditional scaffold formation technique due to its innovative and new addition process. This technique is being studied by Massachusetts Institute of Technology, Carnegie Mellon University, University of Michigan of United States, National University of Singapore and Tsinghua University of China. Wherein, some researchers, such as D. Hutmacher research team of National University of Singapore, M. J. Cima research team of Massachusetts Institute of Technology and Bone Tissue Engineering Center of Carnegie Mellon University, use existing rapid prototyping processes, devices and scaffold materials to produce scaffolds directly. While some of other researchers, such as, Laser Rapid Prototyping Center of Tsinghua University, are committed to developing new rapid prototyping process for scaffold materials of the Tissue Engineering to meet the special requirements for scaffold formation. After 20 years' efforts, there are several kinds of techniques for achieving tri-dimensional rapid prototyping, such as, SLA, FDM, 3DP, SLS and LOM.

Low-temperature deposition and manufacturing process (LDM) is a new process developed by Materials Processing Technology Institute of Department of Mechanics of Tsinghua University to meet the special requirements of biological material formation. The low-temperature deposition and manufacturing process is performed by preparing the scaffold materials into liquid and extruding the liquid solution in filiform shape via nozzles to be stacked and shaped in a low-temperature formation chamber.

The specific process of low-temperature deposition and manufacturing is that: building a tri-dimensional model by using modeling software, and layering the model by using layering process software to obtain coordinate codes for formation; selecting materials for experiments, and preparing solution for standby application in light of proper scale; adding the materials into the ejector of each nozzle of the forming equipment, and controlling the scan, extrusion and eruption movement of each nozzle by the control software in the PC based on the input layering file and defined processing parameters, thereby enabling the materials ejected from the nozzles to solidify rapidly and bond together to stack and form a frozen scaffold; putting the frozen scaffold into the freeze dryer, performing freeze drying treatment, and removing solvent to obtain a scaffold in solid-state under normal temperature, during the process, the sublimation of the solvent causes micropore structures to be formed in the frozen scaffold.

At present, the Department of Mechanics of Tsinghua University has possessed tri-dimensional scaffold controlled formation devices for respective single nozzles and dual-nozzles, and has designed and fabricated piston extrusion nozzles. For example, a rapid prototyping machine for biological materials CLRF-2000-II independently researched and developed by Advanced Manufacturing and Rapid Prototyping Laboratory of Tsinghua University.

However, a complex tissue or organ in vivo is generically a composite structure formed by two or more different cells or extracellular matrix materials and interrelated among each structure. As the researches deepens, requirements on formation of three-dimensional structure for a plurality of different heterogeneous material arise. The existing single nozzles and dual-nozzles can not meet the requirement for rapid manufacturing complex tissues and organs. A Chinese patent literature (Application No.201110205970.1) relates to a fixed multi-nozzle complex organ precursor three-dimensional controlled forming system, wherein the jet apparatus is formed by two fixed motor-driven nozzles, the forming platform is arranged on the tri-dimensional movement device, different nozzle assemblies are provided with different shaping materials, all the nozzles are located in the same plane, and the working nozzles is aligned with the forming platform by the tri-dimensional movement device when switching nozzles.

A linear stepping motor is fixed on the z-direction movement device. Defined stress can be exerted on the forming materials in the nozzles by the threaded rod while driven by the linear stepping motor, thereby jetting the forming materials from the nozzles. The heating rod and heating-insulated jacket are mounted below the lower part of the nozzles to enable the forming materials in the nozzles to be kept at defined temperature.

Such a design is simple and reliable, but the fixed multi-nozzle forming system has the following drawbacks: the forming platform can only be driven by the tri-dimensional movement device, and position parameters are controlled in orthogonal X axis and Y axis when processing material molding with round cross-section and annular cross-section, thus the accuracy remains to be improved; the fixed multi-nozzles are driven and pressed by threaded rods, and not replaceable, and structural drawbacks exist when assembling cells or printing and processing, thus the number of printed cells, thickness and accurate position of cell layers can not be controlled accurately; it has low forming efficiency, the diameter of the syrup jetted by the motor-driven rapid prototyping nozzles depends on the diameters of the nozzles, while the diameters of the nozzles are in the range of several micrometers, it means a lot of work and it takes a lot of time when cell-containing hydrosol is required to be sprayed on a large scope of plane; it can not spray monolayer cells, because the motor-driven rapid prototyping nozzles jet syrup with diameter of generically above 100 micrometers, but the cells of higher animal have diameters less than 25 micrometers, which means multilayer cells will be jetted in one time; it cannot spray the lateral surfaces of the shaped body, because the motor-driven rapid prototyping nozzles are required to be mounted vertically, if the nozzles are mounted horizontally, the syrup will drop off under its gravity after extruded from the nozzles, thus can not attach to the lateral surface of the shaped body.

### SUMMARY

For overcome the drawbacks of the prior art, the present invention provides a pneumatic manufacturing system for complex tissues and organs, having multiple degrees of freedom and multiple nozzles which is powered by high-pressure gas as power source for spray, and has improved the flexibility and accuracy for forming various cells and forming under multi-azimuths.

The technical solutions of the present invention are described below.

A pneumatic manufacturing system for complex tissues and organs, having multiple degrees of freedom and multiple nozzles, which comprises an X-direction movement member, a Y-direction movement member, a Q-direction rotation member rotating about Y axis, a shell, a lifting platform, a rotating platform, a high-pressure gas source, a multiple-nozzle forming unit, a solution-spraying pressure tank, a temperature control device, a sterilizing device and a control unit, characterized in that, the multiple-nozzle forming unit is mounted on the Q-direction rotation member, the Q-direction rotation member is fixed to and mounted on the X-direction movement member, the X-direction movement member is mounted on the Y-direction movement member at the top of the shell and moves along Y direction, the rotating platform is mounted on the lifting platform located at the bottom of the shell and moving along Z direction, the multiple-nozzle forming unit comprises a plurality of spray valves mounted on the Q-direction rotation member, the high-pressure gas source is connected with a spray valve controller and the solution-spraying pressure tank through gas pipelines respectively, the control unit is connected with the spray valve controller and the temperature controller through control line, the gas output by the spray valve controller and the solution output by the solution-spraying pressure tank converge at the spray valves to erupt the solution.

Another technical feature of the present invention is that the multiple-nozzle forming unit comprises a plurality of spray valves which comprises one or a combination of two of spray valve and eruption valve. The spray valves is arranged on the same fan-shaped sector or periphery, or arranged radially in the same line.

The rotating platform of the present invention is a platform capable of deflecting in multi-directions and multi-angles which has a top of tabulate, round or reticulated structure.

The high-pressure gas source of the present invention comprises an air compressor and an air storage tank, the air storage tank is connected with the spray valve controller and the solution-spraying pressure tank through the cooler and the filter respectively.

The solution-spraying pressure tank of the present invention comprises a solution-spraying pressure tank body and an air inlet conduit, a drainpipe and a temperature sensor arranged in the tank body the solution-spraying pressure tank body has a stepped appearance at the lower part thereof, heating plates are provided outside the stepped body, and a insulating layer covers the exterior of the heating plates.

The present invention has following advantages and prominent effects: the system provided by the present invention can move in multi-degree of freedom, accurately form structures with a round and annular cross-section, and the relative angle between the central axis of the spray valve and the surface of the rotating platform can also vary, the system is capable of spraying the lateral surface of the forming body, convenient for manufacturing a complex curved surface; the system provided by the present invention use pneumatics, so that the accuracy for spray is high and the response speed is fast; and the multiple-nozzle forming unit comprises one spray valve and three eruption valves; the spray valve atomize the liquid and spray it, and then the solvent is rapidly volatilized due to larger contact area of the liquid and air, so that forming efficiency is improved, and the sprayed cells is reliably combined with the formed surface, monolayer cell can be sprayed, and the system has relatively larger spraying swath, higher spraying efficiency, the eruption valves can erupt spraying solution in a filiform shape to form scaffolds with different materials, or in a punctiform shape to spray precisely so that cells can be positioned accurately; the system provided by the present invention employs a multiple-nozzle forming unit, so that the formed structure has dimensions ranging from several nanometers to several centimeters, and the system is suitable for forming materials with wide range of dimensions.

In conclusion, the system provided by the present invention utilizes a multiple-nozzle pneumatic technique to achieve efficient co-forming of complex three-dimensional structures with various heterogeneous materials. The structure dimensions range from several nanometers to several centimeters. The multiple-nozzle forming unit can also perform post-processing for the formed materials, such as crosslinking of polymer materials, organic solvent extraction, recombination of growth factors, to make the manufacturing process more accurate and rapid. The spray and spraying device may be directly introduced into human body via minimally invasive technology to produce in situ and rapidly repair lesion and organs using cells of the patient and extracellular matrix materials.

### BRIEF DESCRIPTIONS OF THE DRAWINGS

FIG. 1 is a three-dimensional structural diagram showing a pneumatic manufacturing system for complex tissues and organs, having multiple degrees of freedom and multiple nozzles of the present invention.

FIG. 2 is a schematic structural diagram of the solution spraying system.

FIG. 3 is a schematic diagram of the solution-spraying pressure tank.

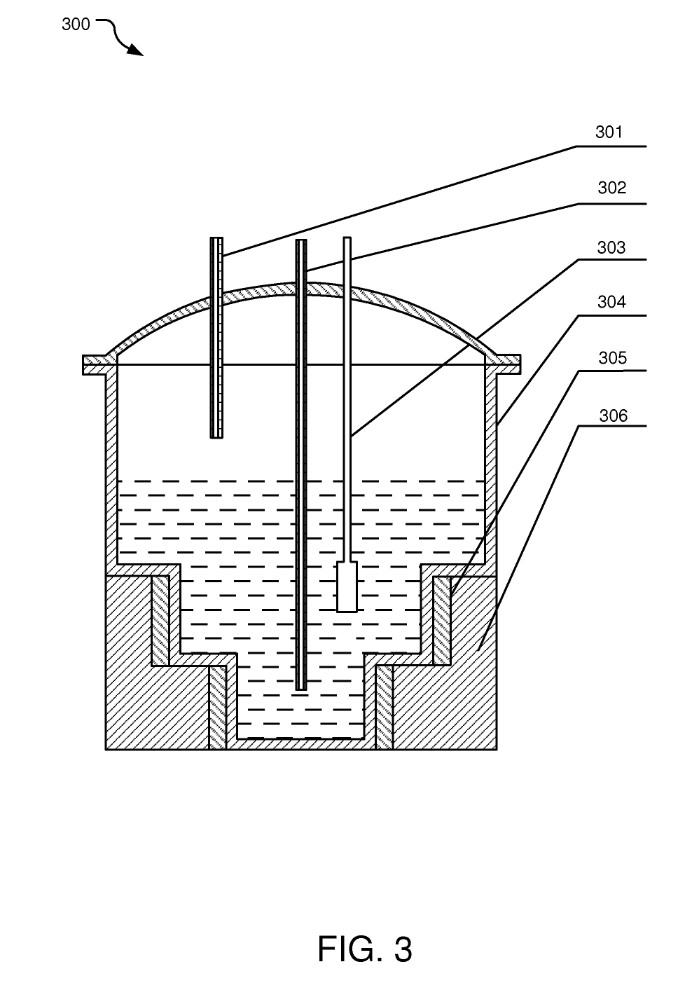

FIG. 4 is a block diagram showing a wiring for control of a pneumatic manufacturing system for complex tissues and organs, having multiple degrees of freedom and multiple nozzles of the present invention.

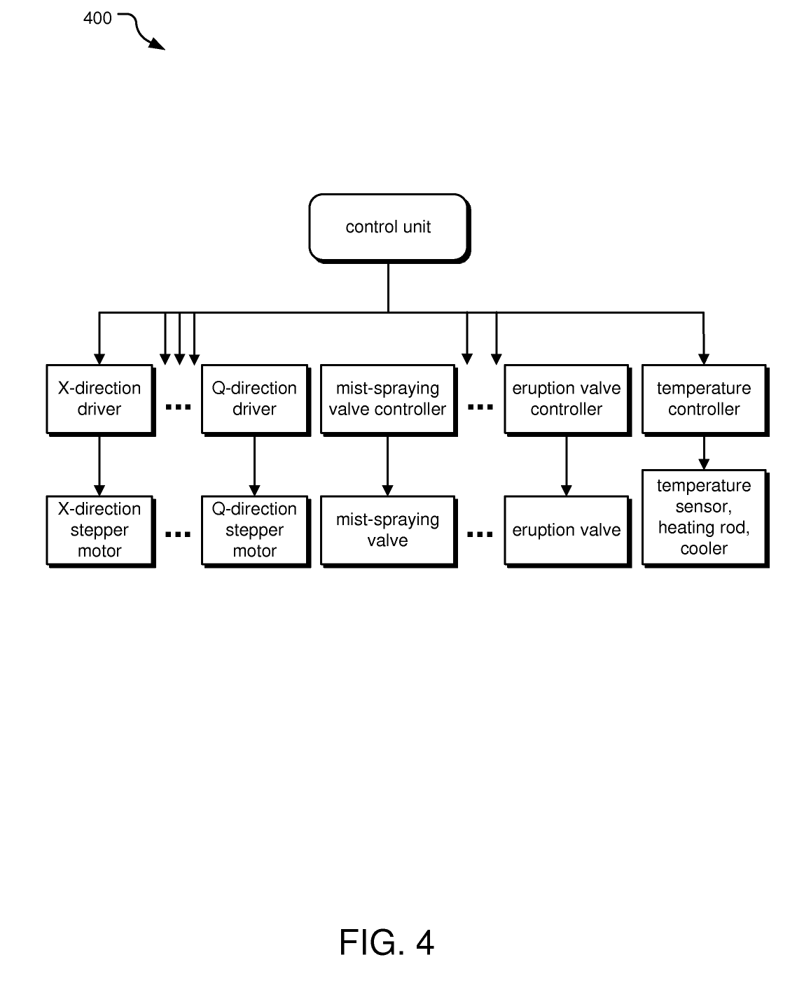

FIG. 5 is a control wiring diagram showing a procedure which the pneumatic manufacturing system, having multiple degrees of freedom and multiple nozzles of the present invention, follows for producing complex tissues and organs.

Wherein: 101—Q-direction rotation member, 102—multiple-nozzle forming unit, 103—temperature controller, 104—rotating platform, 105—lifting platform, 106—X-direction movement member, 107—Y-direction movement member, 108—sterilizing device, 109—electrical control cabinet, 110—high-pressure gas source, 111—control unit, 201—air compressor, 202—pressure gage, 203—air storage tank, 204—cooler, 205—filter, 206—control unit, 207—temperature controller, 208—spray valve controller, 209—solution-spraying pressure tank, 210—spray valve, 301—air inlet conduit, 302—drainpipe, 303—temperature sensor, 304—solution-spraying pressure tank body, 305—heating plate, 306—insulating layer.

### DETAILED DESCRIPTIONS

The present invention is now further described in detail with regard to accompanying figures and embodiments in order to further understand the technical scheme of the present invention.

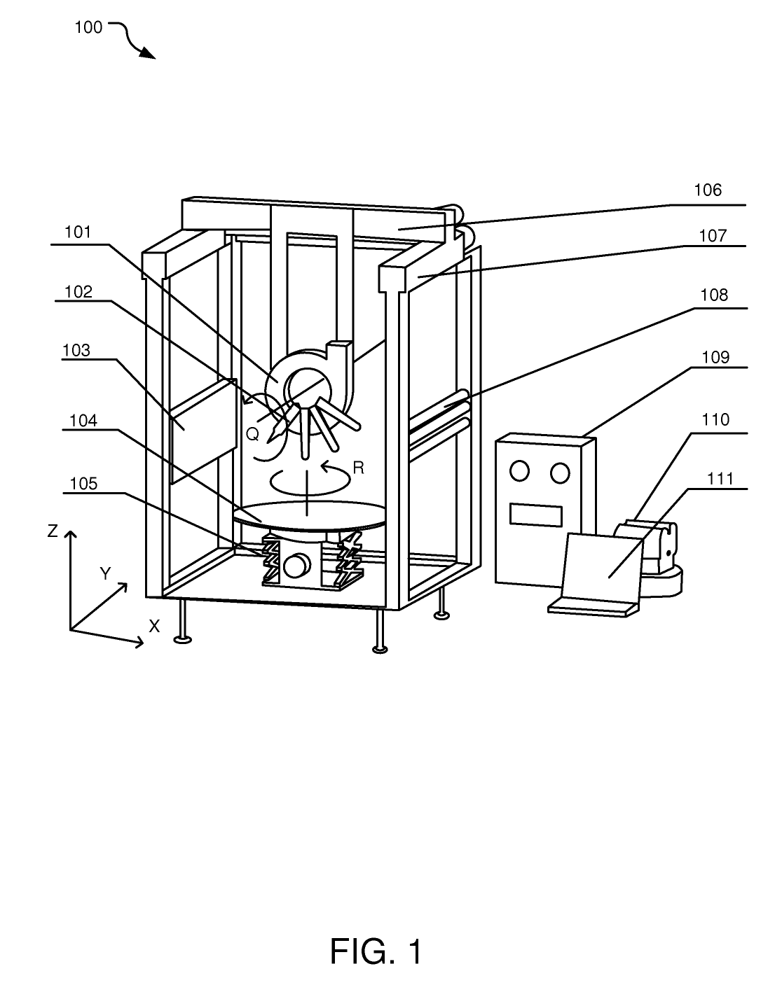

FIG. 1 is a schematic diagram showing the principle of a pneumatic manufacturing system for complex tissues and organs with multiple degrees of freedom and multiple nozzles of the present invention. The system comprises an X-direction movement member 106, a Y-direction movement member 107, a Q-direction rotation member 101 capable of rotating a Y-axis, a shell, a lifting platform 105, a rotating platform 104, a high-pressure gas source 110, a multiple-nozzle forming unit 102, a solution-spraying pressure tank 209, a temperature control device 103, a sterilizing device 108, electrical control cabinet 109 and a control unit 111.

The Q-direction rotation member 101 rotating about Y axis, the lifting platform 105, the rotating platform 104, the multiple-nozzle forming unit 102, the temperature control device 103 and the sterilizing device 108 are provided in the shell, and the X-direction movement member 106 and the Y-direction movement member 107 are mounted at the top of the shell.

The multiple degrees of freedom comprise rectilinear movements in X-direction, Y-direction and Z-direction, R-direction rotation and Q-direction of the rotating platform rotating about Z-direction and Y-direction, respectively, and Q-direction rotation caused by the Q-direction rotation member rotating about Y axis.

The multiple-nozzle forming unit 102 is mounted on the Q-direction rotation member 101, the Q-direction rotation member 101 is fixed to and mounted on the X-direction movement member 106, the X-direction movement member 106 is mounted on the Y-direction movement member 107 at the top of the shell and moves along Y direction, the rotating platform 104 is mounted on the lifting platform 105 at the bottom of the shell moving along Z direction, the high-pressure gas source 110 is connected with the spray valve controller 208 and the solution-spraying pressure tank 209 respectively through gas pipelines, the control unit 206 is connected with the spray valve controller 208 and the temperature controller 303 respectively through control lines, the gas output by the spray valve controller 208 and the solution output by the solution-spraying pressure tank 209 converge at the spray valve, so as to erupt the solution.

The multiple-nozzle forming unit 102 comprises a plurality of spray valves mounted on the Q-direction rotation member 101, the plurality of spray valves comprise one or both of a mist-spraying valve and an eruption valve. The plurality of spray valves can be arranged on the same fan-shaped sector or periphery, or may be also arranged radially along the same line.

The mist-spraying valve erupts liquid in form of fogdrops, and the eruption valve erupts liquid in filiform shape or punctiform shape based on the pressure applied thereof. Four eruption valves are arranged in the same fan-shaped sector uniformly, and using high-pressure gas as the source for driving the spraying action.

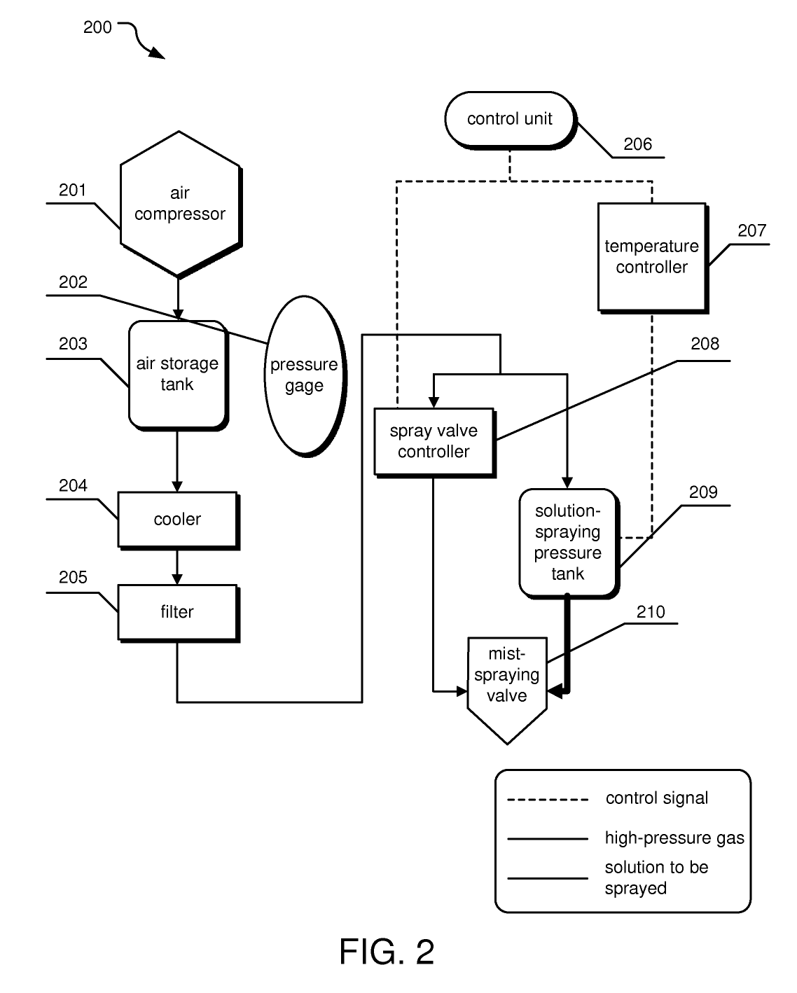

FIG. 2 is a structural diagram showing the solution spraying system. The air compressor 201 produces high-pressure gas, which is then conveyed to the air storage tank 203 to be stored. The air storage tank 203 has functions of storing compressed gas and decreasing the fluctuation of pressure of the compressed gas. The pressure gage 202 shows the gas pressure value in the air storage tank. The high-pressure air output from the air storage tank 203 has very high temperature, and must be cooled down by the cooler 204 to the temperature which meets requirement for operation, and then is filtered by filter 205 to remove water, oil and other contamination particles in the high-pressure air. Wherein, the high-pressure gas source 110 comprises an air compressor 201, an air storage tank 203, a pressure gage 202, a cooler 204 and a filter 205; the high-pressure gas subjected to filtration by the filter 205 to consistent with the requirement is divided into two branches, one of which is communicated with the solution-spraying pressure tank 209 in which cell-containing hydrosol is filled, and the high-pressure gas provide applies pressure to the liquid in the solution-spraying pressure tank 209, the liquid outlet of the solution-spraying pressure tank 209 is in communication with the liquid inlet of the mist-spraying valve 210, and the cell-containing hydrosol will flow towards the mist-spraying valve 210 under the pressure. Another branch of high-pressure gas subjected to filtration by the filter 205 to consistent with the requirement is communicated with the spray valve controller 208, and the high-pressure gas output from the spray valve controller 208 is supplied to the gas inlet of the mist-spraying valve 210. After the air at defined pressure and the liquid mix together, under the control of the control unit 206, the hydrosol with cells is atomized and erupted at a defined speed and amount.

The solution-spraying pressure tank 209 has a stepped appearance at the lower part thereof, heating plates 305 are provided surrounding the tank, and an insulating layer 306 covers the heating plates. The temperature sensor 303 measures the temperature of the liquid in the solution-spraying pressure tank 209 in real-time, and the heating plates 305 receive signals from the temperature controller 303 and are actuated to heat once the temperature of the liquid is lower than a defined value, while the insulating layer 306 covers the heating plates to reduce its heat loss.

The eruption valve system has a similar structure as that of the mist-spraying valve system, and they use uniform high-pressure air source 110 and but different spray valves and different spray valve controllers.

The multiple-nozzle forming unit 102 is mounted on the Q-direction rotation member 101, the Q-direction rotation member 101 is mounted on the slider of the X-direction movement member 106, and different spray valves can be utilized by rotating the Q-direction rotation member 101.The working spray valves can be positioned accurately on the substrate under the control of the control unit so as to assemble, print or spray various different materials, comprising high viscosity gel, slurry, solution, and a low viscosity solution containing cells, cell growth factor, crosslinking agent, polymer solution, at proper spatial positions. The system may perform various functions, such as crosslinking of polymer materials, organic solvent extraction, recombination of monolayer cells and nanoscopic scaffold layer of synthetic polymer, besides tri-dimensional controlled assembly of more than two kinds of cells and scaffold materials.

The X-direction movement member 106 is composed of a ball screw pair, a rectilinear guide rail, a slider, a coupler and a stepper motor. Wherein, the ball screw and both ends of the rectilinear guide rail are fixed to the sliders at the left and right sides of the Y-direction movement member 107 respectively, the stepper motor is connected with the ball screw through the coupler.

The lifting platform 105 is mounted at the bottom of the shell, and the rotating platform 104 is mounted at the top of the lifting platform 105.

The rotating platform 104 may also deflect in multi-directions and multi-angles besids rotate about Z direction, and has a top of tabulate, round or reticulated structure.

The rotating platform may deflect from Y direction at a certain angle, and through coordinated movement of the rotating platform 104 and the Q-direction rotation member 101, the angle between the central axis of the spray valve and the surface of the rotating platform 104 can also vary, so as to be capable of spraying to a lateral surface of a body being formed, it's convenient for manufacturing a complex curved surface.

The system further comprises a temperature control device 103. In order to meet the requirement of retaining the activity of biological cells and solidification of materials being formed, the temperature control device 103 maintains the internal temperature of the system within a proper temperature range depending on the requirement, and the temperature control device 103 may be mounted at left side of the shell.

The sterilizing device 108, using ultraviolet rays sterilizing device, may sterilize some biological materials and the interior of the whole system. The sterilizing device may be mounted at the right side of the shell.

The shell covers properly and necessarily protects the system, to ensure smoothly performing the whole manufacturing process and ensure gnotobasis for producing complex tissues and organs, and achieve functions of ground protection, ventilation and thermal insulation.

The control unit 111 provides a user-friendly interface, analyzes and processes tri-dimensional files to be formed, outputs assembly or print instructions with proper timing and data for each nozzle, compensates mechanical deviations, calibrates nozzles, test working conditions of the devices, etc.

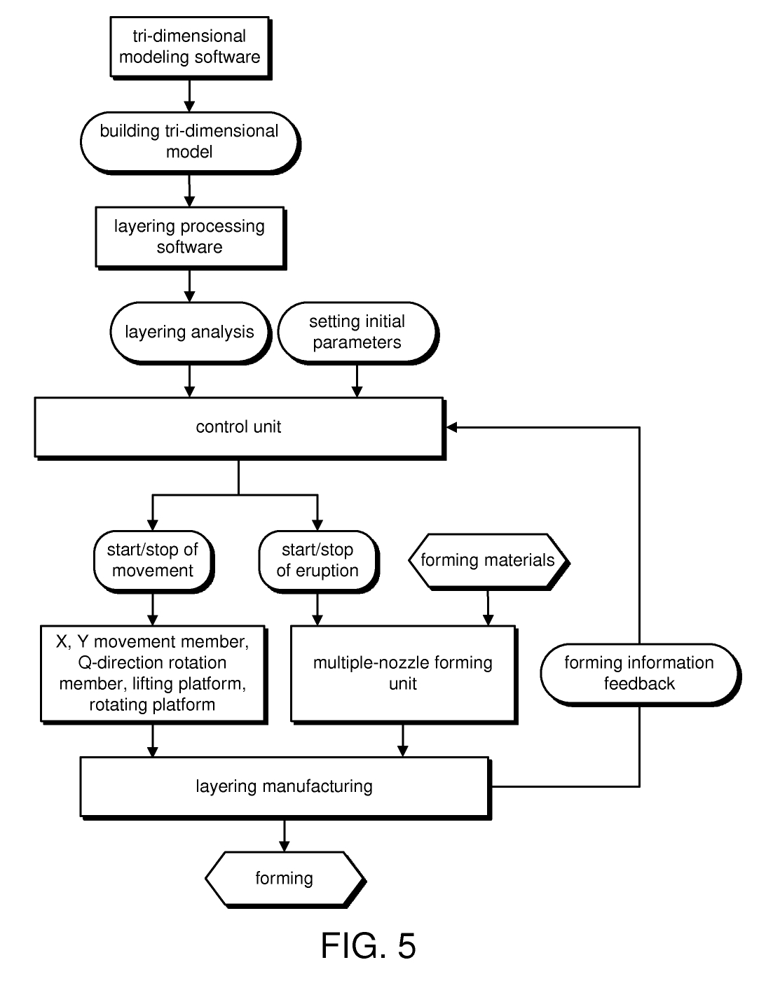

FIG. 5 shows a control wiring diagram showing a pneumatic manufacturing system for complex tissues and organs, having multiple degrees of freedom and multiple nozzles of the present invention. A motion control card is inserted into the PCI slot of the control unit 111, and the terminal board is connected with a interface of the motion control card through control cables. The motor driver and the spray valve controller are directly connected with the terminal board to receive signals from the control unit 111, in order to control the movement of the stepper motor and start and stop of the eruption valve.

With reference to FIG. 6, the operating principle and working process of the present embodiment are described as follows:

Selecting materials for experiments, and preparing forming material with proper ratios of the amounts of the selected materials;

Building a tri-dimensional model of liver lobes by using modeling software, and layering the model by using layering process software to obtain NC codes for formation of a liver, and inputting layering files and processing parameters into computer control software.

Firstly, the sterilizing device 108 is actuated to sterilize the internal environment of the whole shell.

Several related cells, such as, adipose-derived stem cells, hepatocytes, stellate cells, are extracted from a patient. Several cell growth factors, such as endothelial cells growth factors, and well biocompatible biological materials, such as synthetic polymer polyurethane(PU)/tetraethylene glycol (Tetraglycol) solution, polyglycolide and lactide copolymer(PLGA)/tetraethylene glycol solution, gelatin/PBS (or cell culture fluid) solution, sodium alginate/PBS (or cell culture fluid) solution, fibrinogen/PBS (or cell culture fluid) solution, gelatin/fibrinogen/PBS (or cell culture fluid) solution, gelatin/sodium alginate/fibrinogen/PBS (or cell culture fluid) solution, are prepared. The polymer solution containing cells can be further added with cryopreserving agent, such as, dimethyl sulfoxide (DMSO), glycerin and glucose, etc. One of the above cells is mixed with one growth factor solution or one natural polymer solution, such as, adipose-derived stem cells are mixed with endothelial cell growth factors solution, hepatocytes are mixed with gelatin/cell culture fluid, and stellate cells are mixed with gelatin/sodium alginate/fibrinogen/PBS (or cell culture fluid) solution. Firstly, the PU polymer solution is filled into the pressure tank of the spray valve, and then polymer solution containing hepatocytes, polymer solution containing adipose-derived stem cells and cell growth factors, and polymer solution containing stellate cells are filled into 3 pressure tanks with eruption valves, (PLGA)/tetraethylene glycol solution is sprayed out via the eruption valves and form scaffolds, the polymer solution containing adipose-derived stem cells and cell growth factors is sprayed out via the eruption valves and form endodermis of a simulated vascular system, the polymer solution containing hepatocytes and stellate cells is sprayed out via the eruption valves to form cellular layers with different liver functions of hepatic lobule structures, and a synthetic PU polymer solution is sprayed by using mist-spraying valves onto the periphery of the formed hepatocytes layers, enabling the mechanical properties of the formed structures matching with that of the liver arteries and vein blood vessel. If thus formed organ precursors are not to be used immediately, they may be stored in a low-temperature environment at −200° C. for a long period, convenient for storage and transportation. The assembled structures can be directly connected to blood vascular system of a human body, and restore liver without side effects such as cruor, inflammatory reaction, etc.

The initial coordinates of the X-direction movement member 106, the Y-direction movement member 107, the lifting platform 105 and the Q-direction rotation member 101 are set.

The temperature control device 103 is actuated to enable the temperature inside the shell to reach a value required by the experiment and then is kept constant.

When the temperature inside the shell is stable, the forming process is performed. The motion parameters of the movement member are controlled by the control unit 111 depending on the inputted layering files and defined machining parameter, and the controlled spray valves begin to work. The materials erupted out from the spray valves solidify rapidly and bond and stack together and form a certain shape. After finishing stacking of each layer, the rotating platform 104 is lowered by a specific height while driven by the lifting platform 105, if different materials are required to be replaced during this process, a spray valve switching procedure is activated by the control unit 111 so that the lifting platform 105 is controlled to lower by a certain distance, and the working spray valves are controlled to move to defined positions depending on position relationship between spray valves, then the lifting platform 105 is lifted by the same distance to continue forming process.

If a structure with an annular cross-section is to be formed, the spray valves are controlled by the control unit 111 to move to defined positions, the rotating platform 104 is activated, and the rotating platform 104 rotates about its center axis. After the rotating platform rotates by one complete revolution, the lifting platform 105 further lowers by a certain height so as to continue to implement the forming process.

If another layer of material is required to be sprayed onto the surface of the surface being processed, the Q-direction rotation member 101 is activated, the mist-spraying valve 210 is oriented toward a horizontal direction and transferred to one side of the rotating platform 104, and then the rotating platform 104 begins to rotate, while the spray valve is actuated to spray. The lifting platform 105 is actuated to lower by a certain height after defined period of time, so that another layer of material can be sprayed onto the surface of the processed structure by the spray valve.

After different materials are formed on the surface of the forming platform, the multiple-nozzle forming unit 102 is removed out from the forming area according to the procedure, the forming procedure is finished, and then the formed structure can be removed.

The pneumatic manufacturing system for complex tissues and organs, having multiple degrees of freedom and multiple nozzles according to the present invention may use biological materials, such as, colloid, suspension, syrup and molten mass with relatively higher viscosities, or solution systems with relatively lower viscosities comprising one of or a group of more than two of degradable and non-degradable polymer solid or liquid materials, polymer solution containing cells, cell culture fluid, cell growth factor solution, bioactive fluorochrome, inorganic solution, organic solution, aqueous solution.

The pneumatic manufacturing system for complex tissues and organs, having multiple degrees of freedom and multiple nozzles according to the present invention has the following advantages: it can accurately position various material systems in different states, manufacture and spray complex surfaces with physical dimension ranging from several nanometers to several centimeters, and is suitable for forming materials with wide range of dimensions.

What is claimed is:

1. A pneumatic manufacturing system for complex tissues and organs, having multiple degrees of freedom and multiple nozzles, comprising a shell, a multiple-nozzle forming unit (102), a lifting platform (105), a rotating platform (104) mounted on the lifting platform, a solution-spraying pressure tank (209), a temperature controller (103), a sterilizing device (108) and a control unit (111), characterized in that,
the system further comprises an X-direction movement member (106), a Y-direction movement member (107), a Q-direction rotation member (101) capable of rotating about Y axis and a high-pressure gas source (110),
wherein, the multiple-nozzle forming unit (102) is mounted on the Q-direction rotation member (101), the Q-direction rotation member (101) is fixed to and mounted on the X-direction movement member (106), the X-direction movement member (106) is mounted on the Y-direction movement member (107) at the top of the shell and capable of moving along Y direction, the multiple-nozzle forming unit (102) comprises a plurality of spray valves mounted on the Q-direction rotation member (101), the high-pressure gas source (110) is connected with a spray valve controller (208) and the solution-spraying pressure tank (209) through gas pipelines respectively, the control unit (111) is connected with the spray valve controller (208) and the temperature controller (103) respectively through control line via an electrical control cabinet (109), the gas output by the spray valve controller (208) and the solution output by the solution-spraying pressure tank (209) converge at the spray valves to erupt the solution.

2. The pneumatic manufacturing system for complex tissues and organs, having multiple degrees of freedom and multiple nozzles of claim 1, characterized in that, the multiple-nozzle forming unit (102) comprises a plurality of spray valves which comprises one of a mist-spraying valve and an eruption valve or a combination thereof.

3. The pneumatic manufacturing system for complex tissues and organs, having multiple degrees of freedom and multiple nozzles of claim 2, characterized in that, the plurality of spray valves are arranged on the same fan-shaped sector or periphery, or arranged radially along the same line.

4. The pneumatic manufacturing system for complex tissues and organs, having multiple degrees of freedom and multiple nozzles of claim 1, characterized in that, the rotating platform (104) is a platform capable of deflecting in multi-directions and by multi-angles which has a top in the shape of tabulate, round or reticulated structure.

5. The pneumatic manufacturing system for complex tissues and organs, having multiple degrees of freedom and multiple nozzles of claim 1, characterized in that, the high-pressure gas source (110) comprises an air compressor (201) and an air storage tank (203), the air storage tank is connected with the spray valve controller (208) and the solution-spraying pressure tank (209) through a cooler (204) and a filter (205) respectively.

6. The pneumatic manufacturing system for complex tissues and organs, having multiple degrees of freedom and multiple nozzles of claim 1, characterized in that, the solution-spraying pressure tank comprises a solution-spraying pressure tank body (304) and an air inlet conduit (301), a drainpipe (302) and a temperature sensor (303) disposed inside the tank body; the solution-spraying pressure tank body has a stepped shape at the lower part thereof, heating plates (305) are provided outside the stepped body, and a insulating layer (306) covers the exterior of the heating plates.
